(19) United States
(12) Patent Application Publication
(10) Pub. No.: US 2025/0360995 A1
(43) Pub. Date: Nov. 27, 2025

(54) METHOD FOR DETERMINING WATERCRAFT BEARING AND SPEED FROM WAVE WAKE OBSERVATION

(71) Applicant: RTX BBN Technologies, Inc., Cambridge, MA (US)

(72) Inventors: William B. Coney, Watertown, MA (US); John Philip Granville, Bedford, MA (US); Michael Bruce Goldsmith, Framingham, MA (US); Arda Cam, Watertown, MA (US); Noa Choi, Cambridge, MA (US)

(21) Appl. No.: 19/076,244

(22) Filed: Mar. 11, 2025

Related U.S. Application Data
(60) Provisional application No. 63/650,076, filed on May 21, 2024.

(51) Int. Cl. B63B 79/15; G01L 1/24

(52) U.S. Cl. CPC B63B 79/15; G01L 1/242

(57) ABSTRACT

A system, apparatus, and method are provided which process a disturbance record including a record of wake disturbances at a reference boundary according to time and position and calculate bearing and speed information associated with an object and a body of water based on processing the disturbance record. The bearing and speed information includes a speed at which the object crossed a point along the reference boundary and a direction in which the object is traveling.

### CROSS-REFERENCE TO RELATED APPLICATIONS

This application claims the benefit of U.S. Provisional Application No. 63/650,076 filed May 21, 2024, the disclosure of which is incorporated herein by reference in its entirety.

### STATEMENT OF FEDERAL SUPPORT

This invention was made with United States Government support under contract 70RSAT22CB0000018 awarded by the U.S. Government. The Government has certain rights in the invention.

### BACKGROUND

The present disclosure relates to vehicle traffic monitoring systems and, in particular, to watercraft traffic monitoring systems in maritime and inland waterways applications.

Acoustic monitoring is a component of studying the wide variety of sounds and sound sources in maritime applications. For example, some techniques may implement ocean acoustics in association with general oceanography, studying of marine mammals, monitoring of natural and anthropogenic ocean noise, defense, and ocean exploration.

Some traffic monitoring systems in maritime applications may include applying distributed acoustic sensing (DAS) for the detection of watercraft transiting over a fiber optic cable. In some cases, low frequency acoustic energy associated with DAS is unable to propagate to a significant range for watercraft detection and traffic monitoring in shallow water. For example, long wavelengths associated with low frequency acoustic measurements on DAS systems may be cut-off by the water depth which, in some approaches, precludes a practical use of acoustic beamforming techniques to estimate a target bearing associated with a watercraft. That is, for example, in shallow water, the low frequency nature of detections prevents effective estimation of the target bearing using beamforming.

### BRIEF DESCRIPTION

According to an aspect of the disclosure, a system is provided including: a computing device configured to: process a disturbance record including a record of wake disturbances at a reference boundary according to time and position; and calculate bearing and speed information associated with an object and a body of water based on processing the disturbance record, wherein the bearing and speed information includes: a speed at which the object crossed a point along the reference boundary; and a direction in which the object is traveling.

In any one or combination of the embodiments disclosed herein, the computing device is further configured to: generate, based on processing the disturbance record, crossing extent information associated with the object and the reference boundary, wherein the crossing extent information includes: a location at the reference boundary at which the object crossed the reference boundary; and temporal information associated with when the object crossed the reference boundary, wherein the computing device is configured to calculate the bearing and speed information based on processing the crossing extent information.

In any one or combination of the embodiments disclosed herein, the disturbance record includes a wake pattern associated with a wake disturbance, wherein the computing device is further configured to: identify an angle of an apex associated with the wake pattern; and generate the crossing extent information based on the angle of the apex.

In any one or combination of the embodiments disclosed herein, the computing device is further configured to: calculate, based on processing the disturbance record, an outward speed of a wake disturbance from a location at the reference boundary where the wake disturbance is first observed, wherein the computing device is configured to calculate the bearing and speed information based on the outward speed of the wake disturbance.

In any one or combination of the embodiments disclosed herein, the computing device is further configured to: determine, based on processing the disturbance record and a second disturbance record, an approach direction of the object with respect to the reference boundary, wherein the computing device is configured to calculate the bearing and speed information based on the approach direction of the object.

In any one or combination of the embodiments disclosed herein, the computing device is further configured to: calculate, based on the disturbance record, a leading disturbance velocity associated with a wake disturbance and trailing disturbance velocity associated with the wake disturbance, wherein the computing device is configured to calculate the bearing and speed information based on the leading disturbance velocity and the trailing disturbance velocity.

In any one or combination of the embodiments disclosed herein, the system further includes a fiber-optic cable disposed in the body of water, wherein the reference boundary is based on a shape of the fiber-optic cable; and an interrogator device configured to: emit a laser pulse into the fiber-optic cable; and determine at least one of pressure, vibration, and strain at one or more channels of the fiber-optic cable, based on backscattered light received at the interrogator device via the fiber-optic cable, wherein the at least one of the pressure, vibration, and strain is associated with one or more acoustic waves incident the fiber-optic cable; and provide, based on determining the pressure, vibration, or strain, the disturbance record.

In any one or combination of the embodiments disclosed herein, the system further includes an array of sensor devices disposed in the body of water, wherein the reference boundary is based on a shape of the array; wherein the computing device is configured to: determine at least one of pressure, vibration, and strain at one or more of the sensor devices included in the array; and provide, based on determining the pressure, vibration, or strain, the disturbance record.

In any one or combination of the embodiments disclosed herein, the object includes a watercraft.

An apparatus is provided including: a memory having computer readable instructions and one or more processors for executing the computer readable instructions, the computer readable instructions controlling the one or more processors to perform operations including: processing a disturbance record including a record of wake disturbances at a reference boundary according to time and position; and calculating bearing and speed information associated with an object and a body of water based on processing the disturbance record, wherein the bearing and speed information includes: a speed at which the object crossed a point along the reference boundary; and a direction in which the object is traveling.

In any one or combination of the embodiments disclosed herein, the computer readable instructions further control the one or more processors to perform operations including: generating, based on processing the disturbance record, crossing extent information associated with the object and the reference boundary, wherein the crossing extent information includes: a location at the reference boundary at which the object crossed the reference boundary; and temporal information associated with when the object crossed the reference boundary, wherein calculating the bearing and speed information is based on processing the crossing extent information.

In any one or combination of the embodiments disclosed herein, the disturbance record includes a wake pattern associated with a wake disturbance, wherein the computer readable instructions further control the one or more processors to perform operations including: identifying an angle of an apex associated with the wake pattern; and generating the crossing extent information based on the angle of the apex.

In any one or combination of the embodiments disclosed herein, the computer readable instructions further control the one or more processors to perform operations including: calculating, based on processing the disturbance record, an outward speed of a wake disturbance from a location at the reference boundary where the wake disturbance is first observed, wherein calculating the bearing and speed information is based on the outward speed of the wake disturbance.

In any one or combination of the embodiments disclosed herein, the computer readable instructions further control the one or more processors to perform operations including: determining, based on processing the disturbance record and a second disturbance record, an approach direction of the object with respect to the reference boundary, wherein calculating the bearing and speed information is based on the approach direction of the object.

In any one or combination of the embodiments disclosed herein, the computer readable instructions further control the one or more processors to perform operations including: calculating, based on the disturbance record, a leading disturbance velocity associated with a wake disturbance and trailing disturbance velocity associated with the wake disturbance, wherein calculating the bearing and speed information is based on the leading disturbance velocity and the trailing disturbance velocity.

A method is provided including: processing a disturbance record including a record of wake disturbances at a reference boundary according to time and position; and calculating bearing and speed information associated with an object and a body of water based on processing the disturbance record, wherein the bearing and speed information includes: a speed at which the object crossed a point along the reference boundary; and a direction in which the object is traveling.

In any one or combination of the embodiments disclosed herein, the method further includes: generating, based on processing the disturbance record, crossing extent information associated with the object and the reference boundary, wherein the crossing extent information includes: a location at the reference boundary at which the object crossed the reference boundary; and temporal information associated with when the object crossed the reference boundary, wherein calculating the bearing and speed information is based on processing the crossing extent information.

In any one or combination of the embodiments disclosed herein, the disturbance record includes a wake pattern associated with a wake disturbance, and the method further includes: identifying an angle of an apex associated with the wake pattern; and generating the crossing extent information based on the angle of the apex.

In any one or combination of the embodiments disclosed herein, the method further includes: calculating, based on processing the disturbance record, an outward speed of a wake disturbance from a location at the reference boundary where the wake disturbance is first observed, wherein calculating the bearing and speed information is based on the outward speed of the wake disturbance.

In any one or combination of the embodiments disclosed herein, the method further includes: determining, based on processing the disturbance record and a second disturbance record, an approach direction of the object with respect to the reference boundary, wherein calculating the bearing and speed information is based on the approach direction of the object.

Additional features and advantages are realized through the techniques of the present disclosure. Other embodiments and aspects of the disclosure are described in detail herein and are considered a part of the claimed technical concept. For a better understanding of the disclosure with the advantages and the features, refer to the description and to the drawings.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIGS. 1A and 1B illustrate an example of a system in accordance with one or more embodiments of the present disclosure.

FIG. 2 illustrates an example flowchart of a method in accordance with one or more embodiments of the present disclosure.

FIG. 3 illustrates examples of data included in a disturbance record in accordance with one or more embodiments of the present disclosure.

FIG. 4 illustrates an example plot described with reference to apparent speeds of wake disturbances in accordance with one or more embodiments of the present disclosure.

FIG. 5 illustrates an example plot described with reference to determining an approach angle in accordance with one or more embodiments of the present disclosure.

FIG. 6 illustrates an example plot described with reference to calibrations to account for sensitivity in accordance with one or more embodiments of the present disclosure.

FIG. 7 illustrates an example of display which may be generated and displayed by the system in accordance with one or more embodiments of the present disclosure.

FIG. 8 illustrates an example flowchart of a method in accordance with one or more embodiments of the present disclosure.

### DETAILED DESCRIPTION

A detailed description of one or more embodiments of the disclosed apparatus and method are presented herein by way of exemplification and not limitation with reference to the Figures.

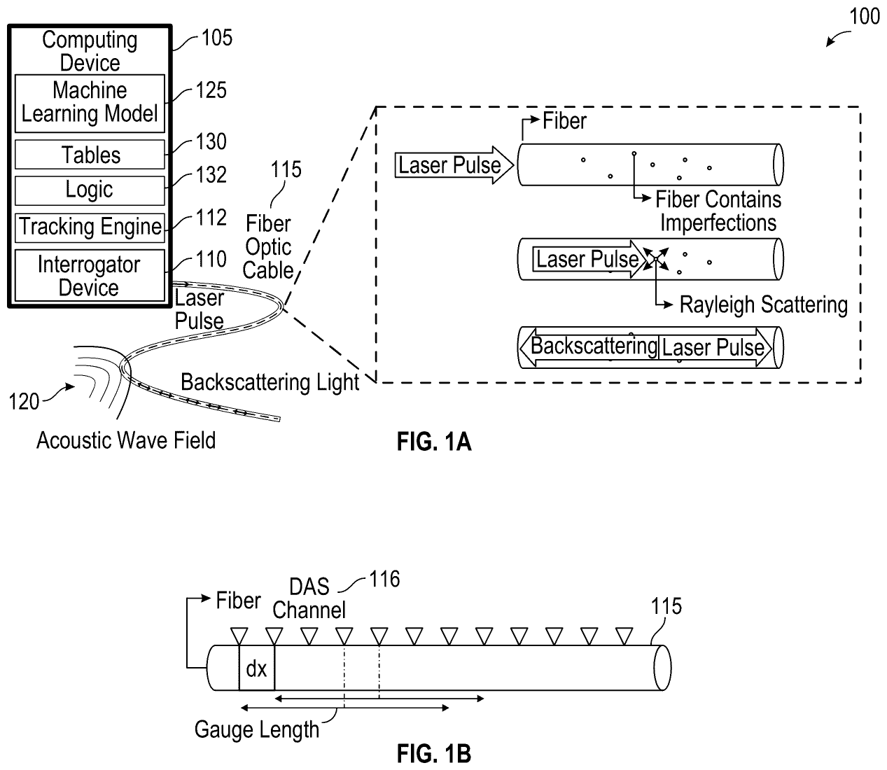

FIGS. 1A and 1B illustrate an example of a system 100 in accordance with one or more embodiments of the present disclosure.

The system 100 may include a computing device 105, and interrogator device 110, a tracking engine 112 (also referred to herein as a wake crossing tracker or a traffic monitoring engine) and a fiber-optic cable 115. In some embodiments, (not illustrated), the system 100 may include multiple instances of the fiber-optic cable 115.

The computing device 105 may be disposed in operable communication with the interrogator device 110. In some embodiments, the interrogator device 110 may be integrated with the computing device 105 as a single device. The computing device 105 and/or interrogator device 110 may be disposed in operable communication with various sensors. For example, the computing device 105 may be in operable communication with the fiber-optic cable 115.

The system 100 supports distributed fiber optic sensing (DFOS) which may use the fiber-optic cable 115 in association with measuring temperature (e.g., distributed temperature sensing (DTS)), strain (e.g., distributed strain sensing (DSS)), and vibrations (e.g., distributed acoustic sensing (DAS)). The system 100 supports distributed acoustic sensing (DAS) using the fiber-optic cable 115 to measure acoustic waves.

The interrogator device 110 may be capable of transmitting laser pulses into the fiber-optic cable 115. The terms transmitting laser pulses and emitting laser pulses may be used interchangeably herein. Rayleigh (elastic) scattering may result from interaction between laser pulses transmitted by the interrogator device 110 and inhomogeneities (natural or manufactured) in the fiber-optic cable 115. A portion of the scattered light is backscattered (e.g., as backscattered pulses or backscattered light) towards the interrogator device 110. In some embodiments, the interrogator device 110 may be a commercial off-the-shelf (COTS) interrogator device, but is not limited thereto.

In association with distributed acoustic sensing, the system 100 may be capable of sensing an acoustic wave field 120 generated due to a moving object (e.g., a watercraft). For example, acoustic waves (sound) associated with the acoustic wave field 120 and incident the fiber-optic cable 115 may cause strain in the fiber-optic cable 115. In some examples, the acoustic waves incident the fiber-optic cable 115 may cause strain such as, for example, vibration, hydrodynamic pressure, and the like at the fiber-optic cable 115.

The interrogator device 110 may observe phase shifts in a backscattered pulse, in which the phase shifts may correspond to strain, vibration, hydrodynamic pressure, or the like in the fiber-optic cable 115.

The fiber-optic cable 115 may include multiple DAS channels 116, spaced by apart by a distance dx. The interrogator device 110 may measure phase difference of each DAS channel 116 over a gauge length 117 that operates as a moving average along the fiber-optic cable 115. In an example, the measured phase difference may be related to strain (length) change at each DAS channel 116. In some other examples, the measured phase difference may be related to vibration change or hydrodynamic pressure change at each DAS channel 116.

Accordingly, for example, at the system 100, incident pressure produces strain observed as a phase shift distributed along the length of the fiber-optic cable 115. Aspects of the system 100 described herein associated with analyzing and processing data representative of the strain and/or phase shift support reliable detection of watercraft which pass over or near (e.g., within a threshold distance of) the fiber-optic cable 115.

Aspects of the fiber-optic cable 115 are not limited to the quantity of DAS channels 116 illustrated at FIGS. 1A and 1B. For example, the fiber-optic cable 115 may have a length of tens of kilometers or more, and the fiber-optic cable 115 may include thousands of DAS channels 116.

The system 100 supports communication between the computing device 105 and other devices (e.g., another computing device 105) of the system 100 via wired communication protocols, wireless communication protocols (e.g., electromagnetic (EM) signals, WiFi, Bluetooth™, ZigBee™, Ubiquiti™, 3G, 4G, LTE, and the like), and/or combinations including one or more of the foregoing.

The computing device 105 is configured to receive, store and/or transmit data generated from components (e.g., interrogator device 110, fiber-optic cable 115, other sensors, and the like) associated with the system 100. The computing device 105 includes processing components configured to analyze received data. The computing device 105 includes processing components configured to provide data (and/or control signals to other components of the system 100. The computing device 105 includes any number of suitable components, such as processors, memory, communication devices and power sources.

In various embodiments, the computing device 105 or the system 100 may include user interface components such as, for example, a display screen, speaker, microphone, wearable devices, keyboard, mouse, printer, touchpad, game controllers, and haptic devices. The computing device 105 and system 100 may provide data to a user or receive inputs from the user via the user interface components.

The computing device 105 may include processing circuitry capable of executing instructions stored on a memory of the computing device 105 in association with performing one or more functions described herein. The processor may utilize data stored in the memory as a neural network. The neural network may include a machine learning architecture. In some other aspects, the neural network may be or include any suitable machine learning network for performing operations described herein. Non-limiting examples of the machine learning network include a deep learning network, a convolutional neural network, a reconstructive neural network, a generative adversarial neural network, or any other neural network capable of accomplishing functions of the computing device 105 described herein. Some elements stored in the memory may be described as or referred to as instructions or instruction sets, and some functions of the computing device 105 may be implemented using machine learning techniques.

The system 100 may include machine learning model(s) 125 which may be trained and/or updated based on training data and field data provided or accessed by any devices or systems described herein. The machine learning model(s) 125 may be implemented at computing device 105, the interrogator device 110, or the tracking engine 112.

The machine learning model(s) 125 may be built and updated (e.g., by any of the computing device 105, the interrogator device 110, or the tracking engine 112) based on the training data (also referred to herein as training data and feedback). The machine learning model(s) 125 may be provided in any number of formats or forms. Example aspects of the machine learning model(s) 125, such as generating (e.g., building, training) and applying the machine learning model(s) 125, are described with reference to the figure descriptions herein. The system 100 may include rule-based tables 130 but is not limited thereto. The system 100 may include logic 132 incorporating Bayesian probability or statistics.

In accordance with one or more embodiments of the present disclosure, the system 100 may support watercraft traffic monitoring and detection of watercraft based on processing sensor data (e.g., strain, vibration, hydrodynamic pressure, or the like provided by the fiber-optic cable 115 and interrogator device 110) by the computing device 105 or tracking engine 112, using the machine learning model(s) 125, the rule-based tables 130, or the logic 132.

In one or more embodiments, aspects of the system 100 (e.g., the tracking engine 112) may be implemented at the computing device 105, another computing device 105 (not illustrated) in electronic communication with the computing device 105 via a wired and/or wireless communication protocol, the interrogator device 110, and/or processing circuitry included in any of the devices. In the example of FIGS. 1A and 1B, interrogator device 110 may be located at a target area associated with watercraft traffic monitoring and detection of watercraft, or the interrogator device 110 may be located within a threshold distance (e.g., based on length of the fiber-optic cable 115 connected to the interrogator device 110) of the target area. In some cases, the computing device 105 (and tracking engine 112) may be located with the interrogator device 110 or may be located at a site remote from the interrogator device 110. In some cases, the computing device 105 may be a server.

In accordance with one or more embodiments of the present disclosure, the fiber-optic cable 115 may be positioned at the bottom of a body of water (e.g., a sea bottom, a lake bottom, or the like), in which the portion of the body of water where the fiber-optic cable 115 is located and where wake disturbances are detected is relatively shallow. For example, a distance between the bottom of the body of water and the surface of the body of water may be a distance supportive of the techniques described herein associated with watercraft traffic monitoring and detection of watercraft. Alternatively, the fiber-optic cable 115 may be shallowly buried in the sediment at the bottom of the sea or lake, instead of sitting on the sea or lake floor. Moreover, the fiber-optic cable 115 may include strength members, such as armor inside the cable. For example, the fiber-optic cable 115 may include an armored mechanical protection layer which increases the mechanical strength of the fiber-optic cable 115 and improves the corrosion resistance of the fiber-optic cable 115 with respect to an environment (e.g., body of water, sea bottom) where the fiber-optic cable 115 is located.

As will be described herein, according to one or more embodiments of the present disclosure, the system 100 supports techniques for watercraft traffic monitoring and detection of watercraft based on observed signatures associated with a watercraft. For example, the observed signatures may include pressure disturbances associated with gravity waves (also referred to herein as surface waves or wakes) generated by a disturbance such as, for example, a watercraft moving on the water surface of the body of water. The system 100 is capable of correlating detection signatures associated with a watercraft and crossings of the watercraft over the fiber-optic cable 115 with pressure disturbances of a very low frequency at the fiber-optic cable 115. These pressure disturbances (also referred to herein as wake disturbances), or wake waves, trail behind the watercraft and arise due to the watercraft's motion along the water surface. In other words, as the watercraft travels along the water surface, low-frequency wake waves are generated and trail the watercraft as the watercraft continues to move along the water surface. These wake waves are detectable by the system 100. According to one or more embodiments of the present disclosure, the system 100 is capable of tracking, based on the wake waves, the speed and bearing of the watercraft as the watercraft moves in relation to the fiber optic cable 115. As described herein, the term wake disturbance refers to a disturbance associated with surface waves generated by a body moving on or near a surface of water.

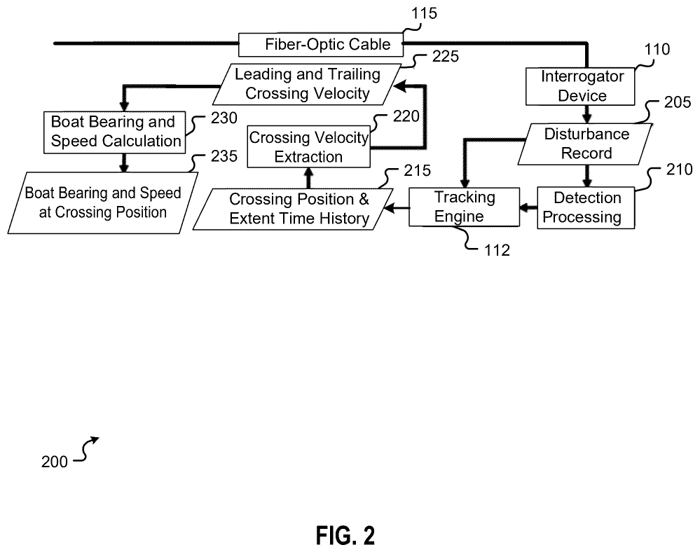

FIG. 2 illustrates an example block diagram of a method 200 in accordance with one or more embodiments of the present disclosure. The method 200 may be implemented by the example aspects of a system 100 described herein. Aspects of the method 200 may be implemented by a computing device 105 described herein, for example, by a interrogator device 110 and a tracking engine 112 described herein.

The method 200 includes providing, by the interrogator device 110, a disturbance record 205. The disturbance record 205 may include a record of disturbances at the fiber-optic cable 115 with respect to a function of time and position. For example, the disturbance record 205 may include disturbances at various positions along a sensing boundary (also referred to herein as a reference boundary) (e.g., positions corresponding to DAS channels 116 of the fiber-optic cable 115). In some aspects, the sensing boundary may correspond to an imaginary boundary at the surface of the water, above the fiber-optic cable 115. In some other aspects, the sensing boundary may correspond to the fiber-optic cable 115.

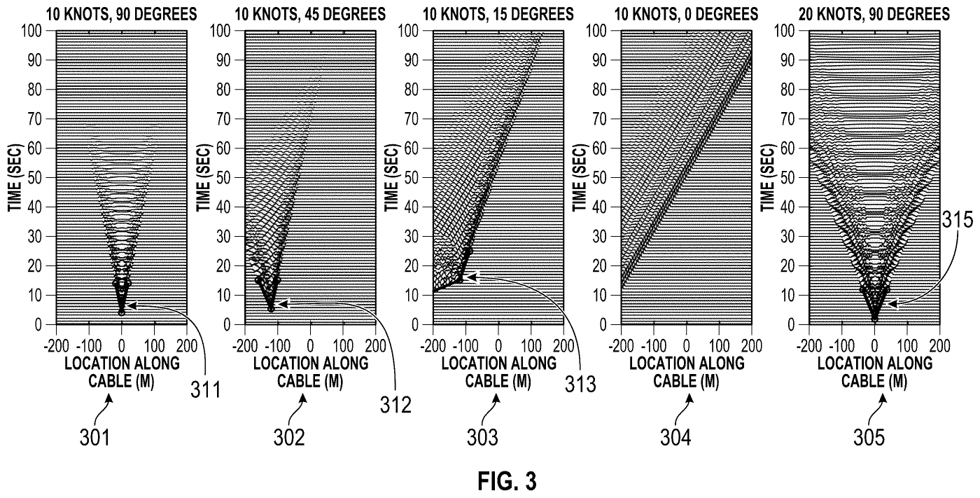

Non-limiting examples 301 through 305 of data included in the disturbance record 205 are illustrated at FIG. 3.

Example 301 is an example of a watercraft traveling at a speed of 10 knots, at an angle of 90 degrees with respect to the fiber-optic cable 115. Example 302 is an example of a watercraft traveling at a speed of 10 knots, at an angle of 45 degrees with respect to the fiber-optic cable 115. Example 303 is an example of a watercraft traveling at a speed of 10 knots, at an angle of 15 degrees with respect to the fiber-optic cable 115. Example 304 is an example of a watercraft traveling at a speed of 10 knots, at an angle of 0 degrees with respect to the fiber-optic cable 115. Example 305 is an example of a watercraft traveling at a speed of 20 knots, at an angle of 90 degrees with respect to the fiber-optic cable 115.

Non-limiting examples of time and position where the watercraft intercepts the fiber-optic cable 115 are given by the inflections 311 through 313 and inflection 315 (e.g., apex of the respective “V” shapes at the inflections) included in the disturbance record 205.

In an example, for a given point of intercept, the slope about the point of intercept corresponds to the apparent speed at which the wake disturbance travels along the length of the fiber-optic cable 115, for example, to either side of the watercraft intercept position. That is, for example, watercraft intercept time and position, and apparent speed of a corresponding wake disturbance is visible in the disturbance record 205.

In some aspects, as seen with reference to examples 301 through 305, the disturbance behavior observed on the fiber-optic cable 115 is more complex when crossing occurs at an oblique angle (e.g., as illustrated at example 303 in which the watercraft is traveling at an angle of 15 degrees with respect to the fiber-optic cable 115).

The fiber-optic cable 115 and the sensing boundary described herein are not limited to a linear form. More complex cable geometries can be used. For example, the fiber-optic cable 115 (and corresponding sensing boundary) may be a straight line, a zig zag line, a curved line, an s-shaped line, or any other suitable shape supportive of the techniques described herein.

At 210, the method 200 may include performing detection processing. In an example, detection processing may include directly providing crossing extent (CE) information. The crossing extent information may include temporal information and positional information associated with when a watercraft crossed (or when the watercraft is predicted to cross) the fiber-optic cable 115. The crossing extent information may also be referred to as a disturbance extent at the crossing. In an example, the method 200 may include providing the crossing extent information to the tracking engine 112.

Additionally, or alternatively, the method 200 may include providing the disturbance record 205 to the tracking engine 112, without generating or providing the crossing extent information. In an example, the tracking engine 112 may generate or extract the crossing extent information based on processing the disturbance record 205.

For example, at 215, the method 200 may include generating information about the extent and evolution of the wake disturbance as the wake disturbance crosses the fiber-optic cable 115. In some aspects, at 215, the method 200 may include determining the crossing extent information. The crossing extent information may include, but is not limited to, the information about the extent and evolution of the wake disturbance. The crossing extent information may include crossing position and crossing extent time history. The crossing extent information may include watercraft intercept time and position, and apparent speed of a corresponding wake disturbance is visible in the disturbance record 205 as described herein.

In some aspects, at 215, the method 200 may include imaging (e.g., by the tracking engine 112) the crossing extent information. For example, the method 200 may include generating temporal information and positional information associated with when the wake disturbance associated with the watercraft crossed the fiber-optic cable 115. The temporal information and positional information associated with the crossing may also be referred to herein as wake crossing position and extent time history. Embodiments of the present disclosure support fully automated generation of the wake crossing extent information. Embodiments of the present disclosure support partially manual extraction of crossing extent information.

At 220, the method 200 may include extracting (e.g., by the tracking engine 112) apparent wake disturbance crossing velocity information. The wake crossing velocity information may be, for example, an apparent outward speed (Uₓ) of the wake disturbance from a location on the fiber-optic cable 115 where the wake disturbance is first observed. The apparent wake disturbance crossing velocity information of 220 is the output of 215. The apparent wake disturbance crossing velocity information is expressed as the apparent velocity of the disturbance along the length of the fiber-optic cable 115.

Example aspects of determining the crossing velocity information from a cable crossing (also referred to herein as boat speed from cable crossing) are described with reference to FIG. 3. For a watercraft crossing the fiber-optic cable 115, the method 200 may include deducing (e.g., calculating) the speed of the watercraft from the speed at which the corresponding wake disturbance expands.

In an example, at 220, the method 200 may include calculating the apparent outward speed (Uₓ) (also referred to herein as a crossing velocity) of the wake disturbance from the point where the wake disturbance is first observed based on the equation Uₓ=U sin(α_{w}), where U=boat speed and α_{w}=wake angle.

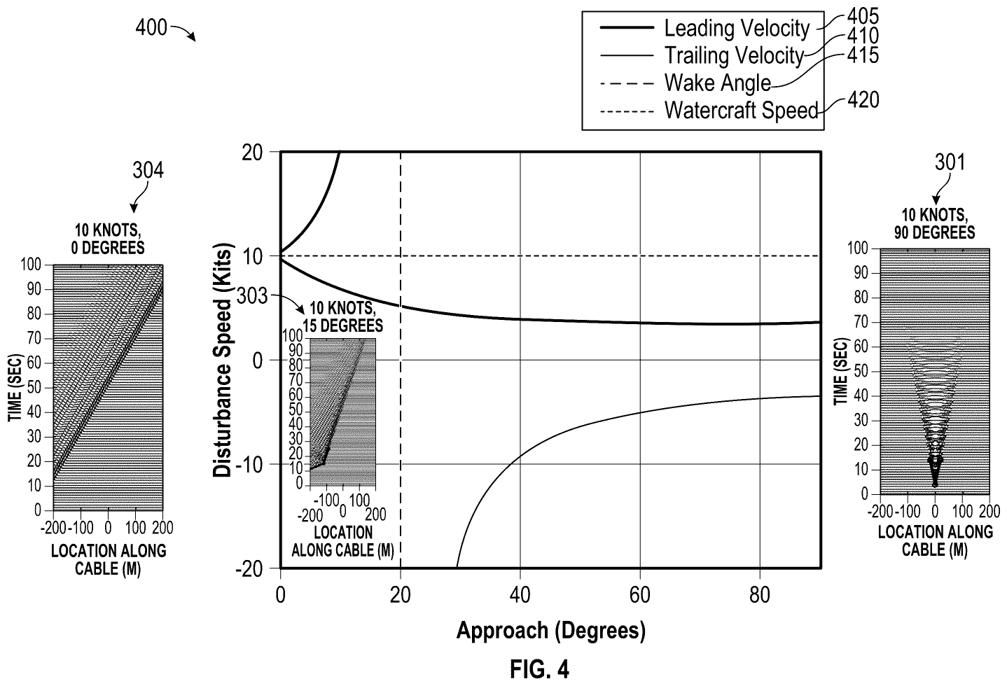

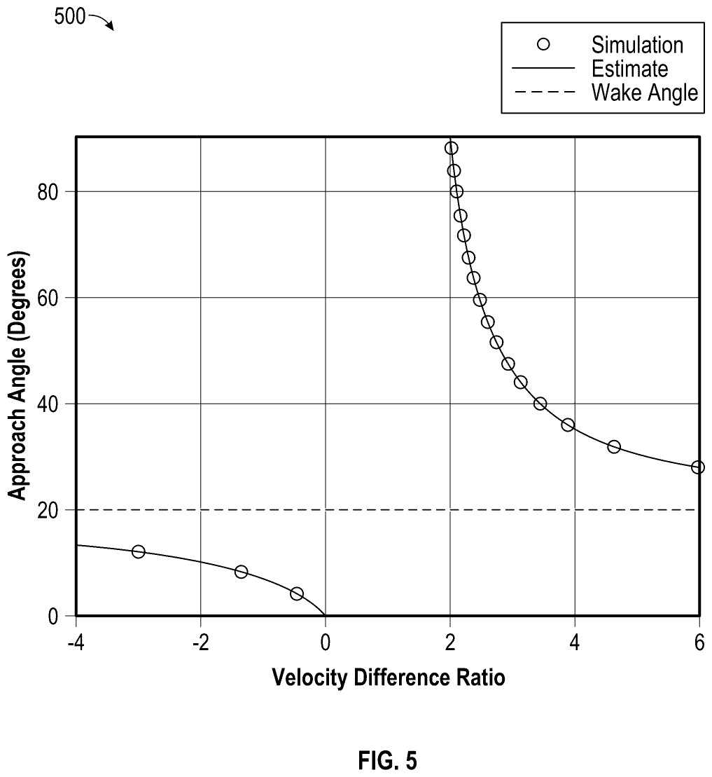

At 225, the method 200 may include determining, from the crossing velocity information, leading and trailing crossing velocity information. The output of 225 is broken out into the velocity component traveling in each direction along the fiber-optic cable 115. The leading and trailing crossing velocity information may include leading disturbance velocity (U_{leading}) and trailing disturbance velocity (U_{trailing}), and example aspects of determining the leading disturbance velocity (U_{leading}) and trailing disturbance velocity (U_{trailing}) are described with reference to FIG. 4 and FIG. 5.

FIG. 4 illustrates an example plot 400 described with reference to an example of apparent speeds of wake disturbances in accordance with one or more embodiments of the present disclosure. Plot 400 explores the speed (in knots (kts)) that a wake moves out along the fiber-optic cable 115 from the point of intercept. In some aspects, the leading and trailing wake disturbances travel at speeds that are functions of the approach angle (bearing) of a watercraft.

The “leading” side corresponds with the direction along the fiber-optic cable 115 that the watercraft is traveling. In some aspects, the leading velocity 405 may always be positive.

For approach angles greater than the wake (Kelvin) angle, the trailing velocity 410 has the opposite sign (e.g., is negative). Regarding the terms Kelvin angle and Kelvin wakes, the systems and techniques described herein leverage simulation of Kelvin wakes for a watercraft crossing a cable (e.g., fiber-optic cable 115). For example, a moving disturbance at the water surface may generate gravity waves that exhibit a distinctive “V” shaped wake pattern. The gravity waves move with the disturbance and propagate away from its track. The systems and techniques described herein are based at least in part on the analytic solution first developed by Lord Kelvin, which supports prediction of the waves. In deep water, Kelvin's model predicts waves diverging from track at an angle of 19.47 degrees. The systems and techniques described herein leverage Kelvin's solution was to simulate waves passing across a line representing the cable (e.g., fiber-optic cable 115). The Kelvin Wake simulation shows good qualitative agreement with boat crossings observed via DAS.

For approach angles smaller than the wake angle, the trailing wake moves in the same direction as the leading wake.

When the approach angle and the wake angle are the same angle, the disturbance (e.g., trailing velocity 410) will arrive simultaneously along a swath of the fiber-optic cable 115 (infinite disturbance speed).

Example equations supportive of the relation between approach angle and apparent speed (disturbance speed) in accordance with one or more embodiments of the present disclosure as described herein.

$$\frac{{U}_{leading}}{U} = cos θ - sin θ tan ( \frac{π}{2} - θ - {α}_{w} )$$

For θ>α_{w} (approach angle greater than wake angle),

$$\frac{{U}_{trailing}}{U} = cos θ - sin θ tan ( θ - {α}_{w} )$$

For θ<α_{w} (approach angle less than wake angle),

$$\frac{{U}_{trailing}}{U} = - cos θ - sin θ tan ( θ - {α}_{w} )$$

In accordance with the example equations, the apparent speed is a function of the watercraft speed (U), approach angle (θ), and wake angle (α_{w}).

FIG. 5 illustrates an example plot 500 described with reference to an example of determining approach angle (θ) in accordance with one or more embodiments of the present disclosure.

In an example of determining approach angle (θ), the computing device 105 may find intercept time and position. For example, the computing device 105 may determine that a watercraft crosses the fiber-optic cable 115 at point of inflection in the wake disturbance.

The computing device 105 may find leading and trailing disturbance velocities. In an example, the computing device 105 may determine the leading disturbance velocity (U_{leading}) and trailing disturbance velocity (U_{trailing}) by slope (Δt/ΔUₓ) on each side of intercept (inflection).

The computing device 105 may generate a velocity difference ratio between the leading disturbance velocity (U_{leading}) and the trailing disturbance velocity (U_{trailing}) using the following equation.

$$\frac{{U}_{leading} - {U}_{trailing}}{{U}_{leading}}$$

The computing device 105 may evaluate approach angle (θ) (e.g., in degrees) from simulation results. In some aspects, the approach angle (θ) is a single valued function of the normalized difference in wake disturbance speed.

At 230, the method 200 may include calculating watercraft bearing and speed information 235 (also referred to herein as boat bearing and speed at crossing position). For example, the method 200 may use the output of 225 to calculate the watercraft bearing, watercraft speed, and the position of the crossing (e.g., calculating watercraft bearing and speed information 235). In some aspects, the method 200 may include calculating watercraft bearing and speed information 235 based on leading disturbance velocity (U_{leading}), wake angle (α_{w}), and approach angle (θ).

An example of calculating watercraft speed (U) given an approach angle (θ) (e.g., as determined at 225) in accordance with one or more embodiments of the present disclosure is described herein.

The computing device 105 may estimate watercraft speed (U) from the observed speed of the wake disturbance (i.e., leading disturbance velocity (U_{leading})) in the leading direction using the Equation

$$U = \frac{{U}_{leading}}{cos θ - sin θ tan ( \frac{π}{2} - θ - {α}_{w} )} ,$$

where θ is the approach angle, U is the watercraft speed, and α_{w} is the wake angle.

For crossing at θ=90 degrees, the computing device 105 may estimate watercraft speed (U) using the Equation U=U_{leading} sin(α_{w}).

At transit along the fiber-optic cable 115 at θ=0 degrees, the computing device 105 may estimate watercraft speed (U) using the Equation U=U_{leading}.

In some aspects, at 230, the method 200 may include determining the speed of the watercraft and accounting for bearing ambiguity associated with the watercraft. For example, the computing device 105 may account for bearing ambiguity (e.g., approach direction ambiguity) associated with the watercraft. For example, some other approaches may be unable to resolve north/south ambiguity in the bearing of the watercraft. That is, for example, some other approaches are unable to determine which side of the fiber-optic cable 115 the watercraft approached or came from.

Embodiments of the present disclosure support techniques capable of resolving the ambiguity using additional information. In an example implementation, the computing device 105 may estimate watercraft speed (U) while resolving the bearing ambiguity by incorporating data (e.g., as described herein with reference to fiber-optic cable 115) from a second fiber-optic cable 115 (not illustrated). In an example, the second fiber-optic cable 115 may include some two dimensional geometry (e.g., zig zag line, a curved line, an s-shaped line, or the like) instead of a straight path.

In some aspects, a similar ambiguity issue as the issue described herein is present in beamformed approaches for watercraft traffic monitoring and detection of watercraft.

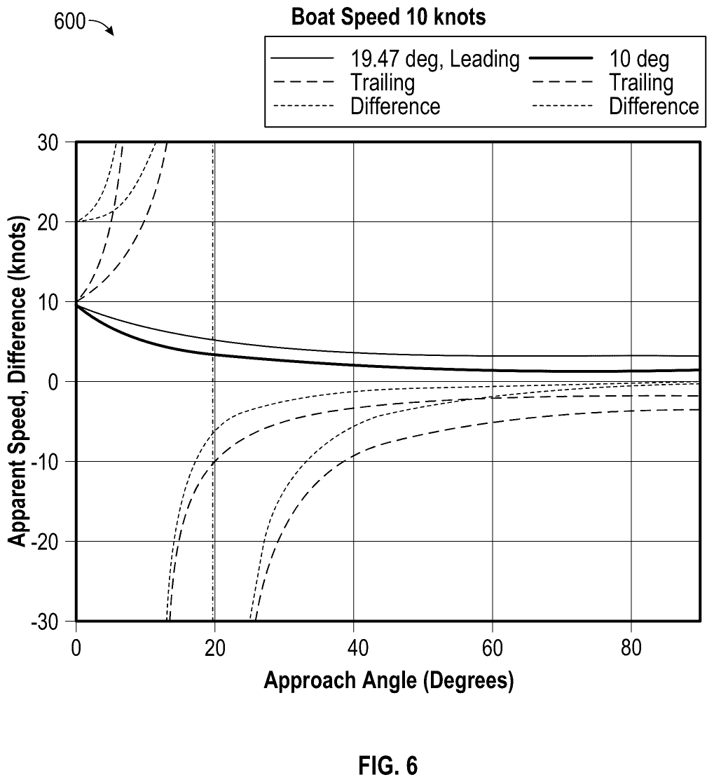

FIG. 6 illustrates an example plot 600 described with reference to an example of calibrations to account for sensitivity in accordance with one or more embodiments of the present disclosure.

The system 100 may support calibrations to account for sensitivity to wake angle (α_{w}). In some cases, due to shallow water and boat geometry effects, observed wake angles associated with a watercraft may be less than the deep-water Kelvin angle of 19.47 degrees. The system 100 supports performing calibration operations during early testing to determine an effective in-situ wake angle for object types of interest (e.g., boat types of interest). Accordingly, for example, the system 100 may be capable of identifying object types of interest based on detected wake angle, even for cases in which a wake angle (e.g., 10 degrees) is less than the deep-water Kelvin angle of 19.47 degrees.

In the example described herein with reference to the method 200, the system 100 is shown using DAS to supply the disturbance record 205 (wake disturbance record). However, embodiments of the present disclosure are not limited thereto. For example, in accordance with additional or alternative embodiments of the present disclosure, the method 200 may include determining or providing the disturbance record 205 based on sensor data provided by other sensors (e.g., hydrophones, pressure sensors, or the like) arranged in a line array.

As described herein, for cases in which an object (e.g., a watercraft) is traveling alongside the fiber-optic cable 115 (e.g., in a direction parallel to the fiber-optic cable 115, a direction substantially parallel the fiber-optic cable 115), the systems and techniques described herein support deducing the speed of the object and the direction of travel of the object directly from the disturbance record 205. The term “substantially,” as used herein, means approximately or actually. The term “substantially parallel” means approximately or actually parallel.

Although the examples described herein have been provided with reference to a watercraft (e.g., a water based vehicle), embodiments of the present disclosure are not limited thereto. For example, the systems and techniques described herein may support watercraft traffic monitoring and detection of other objects (e.g., sea-life, masses, and the like) for which the movement of the object across a body of water generates gravity waves (also referred to herein as surface waves or wakes).

In accordance with one or more embodiments of the present disclosure, the systems and techniques described herein support watercraft traffic monitoring and detection of watercraft based on the insight that observed signatures on a fiber-optic cable 115 (e.g., at the bottom of the sea, a lake, a river, or the like) or line arrays for a watercraft transiting over or along the fiber-optic cable 115 or the line arrays include pressure disturbances associated with free surface waves (i.e., Kelvin wave wakes) generated by the watercraft. The systems and techniques described herein are based on realized principles supportive of deducing the watercraft speed and crossing angle over the fiber-optic cable 115 (or line arrays) from the time history of the pressure disturbances associated with the free surface waves (i.e., Kelvin wave wakes).

The systems and techniques described herein advantageously leverage watercraft wave wake pressure measurements distributed along a line (e.g., pressure measurements described along DAS channels 116 along a fiber-optic cable 115) to determine speed and crossing angle of a passing watercraft. The systems and techniques described herein provide improved watercraft traffic monitoring and detection of watercraft compared to some other approaches, for example, applicable to shallow water conditions. For example, some line array methods focus on beamforming acoustic arrivals from small arrays, but the low frequency nature of the implemented beams prevents effective estimation of target bearings associated with an object to be tracked. In another example, some methods of bottom pressure sensing of watercraft passage pressure disturbances have been implemented for point sensor applications, but such methods fail to describe aspects of the watercraft traffic monitoring and detection of watercraft techniques described herein.

The systems and techniques described herein leverage observations of boat wake waves in DAS results. For example, based on lake testing data, the techniques described herein are based in-part on findings that at low frequency (e.g., <10 Hz), DAS signatures from boats traveling along the water surface strongly correlate with wake waves. According to the testing data, DAS phase has been clearly observed plotted in time and position along the length of tested armored cable (e.g., fiber-optic cable 115). The wake signatures are the most readily observed features on the tested armored cable. Per the testing data, low frequency detections associated with a moving boat may persist for tens of seconds after the boat crosses the cable. The systems and techniques described herein support modeling which indicates observed strain in a fiber is being induced by changes in hydrostatic pressure as the wake waves pass. The testing observed persistent DAS signals associated with gravity (surface) waves in a lake setting.

Aspects of the techniques described herein may support applications related to maritime border defense, harbor defense, watercraft traffic monitoring systems related to a body of water (e.g., lake, port, river, or the like), or any suitable application for providing maritime situational awareness capability.

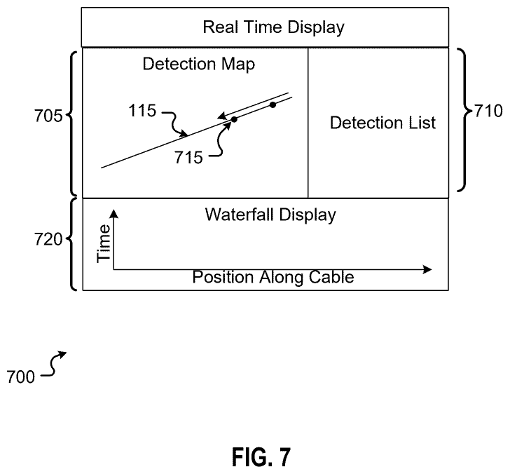

FIG. 7 illustrates an example of display 700 which may be generated and displayed by the system 100 (e.g., by a computing device 105) via one or more user interfaces in accordance with one or more embodiments of the present disclosure.

In an example, the display 700 may include a detection map 705 and a list 710 (also referred to herein as a detection list) of objects detected by the system 100 as having crossed the fiber-optic cable 115. In some aspects, the list 710 may include a list of objects which the system 100 has determined will cross the fiber-optic cable 115 at a determined time point. The system 100 may display, in association with the detection map 705, markers 715 representative of the objects based on locations on the fiber-optic cable 115 at which the objects crossed the fiber-optic cable 115. In some cases, the system 100 may display, in association with the detection map 705, markers 715 representative of objects based on locations on the fiber-optic cable 115 at which the objects are predicted to cross the fiber-optic cable 115.

The system 100 may display, in association with the display 700, a waterfall display 720. The waterfall display 720 may include a temporal axis (e.g., Y-axis) for indicating when an object crossed the fiber-optic cable 115. The waterfall display 720 may include a positional axis (e.g., X-axis) for indicating a location on the fiber-optic cable 115 where the object crossed (or passed over) the fiber-optic cable 115.

In some aspects, the list 710 may include a list of objects which the system 100 has determined will cross the fiber-optic cable 115. For example, the system 100 may display, in association with the temporal axis and the positional axis, an estimated time until the object will cross over (or pass over) the fiber-optic cable 115 and an estimated position at the fiber-optic cable 115 in association with the estimated crossing.

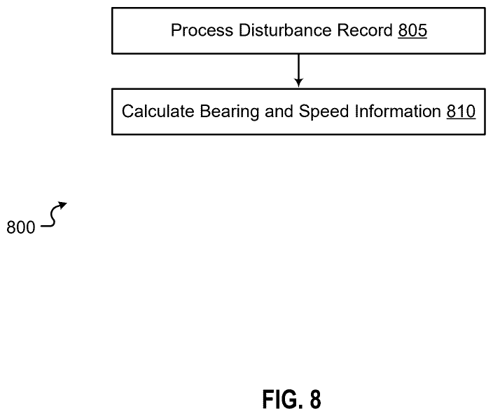

FIG. 8 illustrates an example flowchart of a method 800 in accordance with one or more embodiments of the present disclosure. The method 800 may be implemented by the example aspects of a system 100 as described herein.

At 805, the method 800 includes processing a disturbance record 205 including a record of wake disturbances at a reference boundary according to time and position. As described herein, the term wake disturbance refers to a disturbance associated with surface waves generated by a body moving on or near a surface of water.

At 810, the method 800 includes calculating bearing and speed information 235 associated with an object and a body of water based on processing the disturbance record 205. In some aspects, the bearing and speed information 235 includes: a speed at which the object crossed a point along the reference boundary; and a direction in which the object is traveling.

In some aspects, the method 800 may include generating, based on processing the disturbance record 205, crossing extent information associated with the object and the reference boundary, wherein the crossing extent information includes: a location at the reference boundary at which the object crossed the reference boundary; and temporal information associated with when the object crossed the reference boundary. In some aspects, calculating the bearing and speed information 235 is based on processing the crossing extent information.

In some aspects, the disturbance record 205 includes a wake pattern associated with a wake disturbance. In some aspects, the method 800 may include identifying an angle of an apex associated with the wake pattern; and generating the crossing extent information based on the angle of the apex.

In some aspects, the method 800 may include calculating, based on processing the disturbance record 205, an outward speed of a wake disturbance from a location at the reference boundary where the wake disturbance is first observed. In some aspects, calculating the bearing and speed information 235 is based on the outward speed of the wake disturbance.

In some aspects, the method 800 may include determining, based on processing the disturbance record 205 and a second disturbance record 205, an approach direction of the object with respect to the reference boundary. In some aspects, calculating the bearing and speed information 235 is based on the approach direction of the object.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

In the descriptions of the flowcharts herein, the operations may be performed in a different order than the order shown, or the operations may be performed in different orders or at different times. Certain operations may also be left out of the flowcharts, one or more operations may be repeated, or other operations may be added to the flowcharts.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

The corresponding structures, materials, acts and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the technical concepts in the form disclosed. Many modifications and variations will be apparent to those of ordinary skill in the art without departing from the scope and spirit of the disclosure. The embodiments were chosen and described in order to best explain the principles of the disclosure and the practical application and to enable others of ordinary skill in the art to understand the disclosure for various embodiments with various modifications as are suited to the particular use contemplated.

While the various embodiments to the disclosure have been described, it will be understood that those skilled in the art, both now and in the future, may make various improvements and enhancements which fall within the scope of the claims which follow. These claims should be construed to maintain the proper protection for the disclosure first described.

What is claimed is:

1. A system comprising:
a computing device configured to:
process a disturbance record comprising a record of wake disturbances at a reference boundary according to time and position; and
calculate bearing and speed information associated with an object and a body of water based on processing the disturbance record,
wherein the bearing and speed information comprises:
a speed at which the object crossed a point along the reference boundary; and
a direction in which the object is traveling.

2. The system of claim 1, wherein the computing device is further configured to:
generate, based on processing the disturbance record, crossing extent information associated with the object and the reference boundary, wherein the crossing extent information comprises:
a location at the reference boundary at which the object crossed the reference boundary; and
temporal information associated with when the object crossed the reference boundary,
wherein the computing device is configured to calculate the bearing and speed information based on processing the crossing extent information.

3. The system of claim 2, wherein the disturbance record comprises a wake pattern associated with a wake disturbance,
wherein the computing device is further configured to:
identify an angle of an apex associated with the wake pattern; and
generate the crossing extent information based on the angle of the apex.

4. The system of claim 1, wherein the computing device is further configured to:
calculate, based on processing the disturbance record, an outward speed of a wake disturbance from a location at the reference boundary where the wake disturbance is first observed,
wherein the computing device is configured to calculate the bearing and speed information based on the outward speed of the wake disturbance.

5. The system of claim 1, wherein the computing device is further configured to:
determine, based on processing the disturbance record and a second disturbance record, an approach direction of the object with respect to the reference boundary,
wherein the computing device is configured to calculate the bearing and speed information based on the approach direction of the object.

6. The system of claim 1, wherein the computing device is further configured to:
calculate, based on the disturbance record, a leading disturbance velocity associated with a wake disturbance and trailing disturbance velocity associated with the wake disturbance,
wherein the computing device is configured to calculate the bearing and speed information based on the leading disturbance velocity and the trailing disturbance velocity.

7. The system of claim 1, further comprising:
a fiber-optic cable disposed in the body of water, wherein the reference boundary is based on a shape of the fiber-optic cable; and
an interrogator device configured to:
emit a laser pulse into the fiber-optic cable;
determine at least one of pressure, vibration, and strain at one or more channels of the fiber-optic cable, based on backscattered light received at the interrogator device via the fiber-optic cable, wherein the at least one of the pressure, vibration, and strain is associated with one or more acoustic waves incident the fiber-optic cable; and
provide, based on determining the pressure, vibration, or strain, the disturbance record.

8. The system of claim 1, further comprising:
an array of sensor devices disposed in the body of water, wherein the reference boundary is based on a shape of the array;
wherein the computing device is configured to:
determine at least one of pressure, vibration, and strain at one or more of the sensor devices included in the array; and
provide, based on determining the pressure, vibration, or strain, the disturbance record.

9. The system of claim 1, wherein the object comprises a watercraft.

10. An apparatus comprising:
a memory having computer readable instructions and one or more processors for executing the computer readable instructions, the computer readable instructions controlling the one or more processors to perform operations comprising:
processing a disturbance record comprising a record of wake disturbances at a reference boundary according to time and position; and
calculating bearing and speed information associated with an object and a body of water based on processing the disturbance record,
wherein the bearing and speed information comprises:
a speed at which the object crossed a point along the reference boundary; and
a direction in which the object is traveling.

11. The apparatus of claim 10, wherein the computer readable instructions further control the one or more processors to perform operations comprising:
generating, based on processing the disturbance record, crossing extent information associated with the object and the reference boundary, wherein the crossing extent information comprises:
a location at the reference boundary at which the object crossed the reference boundary; and
temporal information associated with when the object crossed the reference boundary,
wherein calculating the bearing and speed information is based on processing the crossing extent information.

12. The apparatus of claim 11, wherein the disturbance record comprises a wake pattern associated with a wake disturbance,
wherein the computer readable instructions further control the one or more processors to perform operations comprising:
identifying an angle of an apex associated with the wake pattern; and
generating the crossing extent information based on the angle of the apex.

13. The apparatus of claim 11, wherein the computer readable instructions further control the one or more processors to perform operations comprising:
calculating, based on processing the disturbance record, an outward speed of a wake disturbance from a location at the reference boundary where the wake disturbance is first observed,
wherein calculating the bearing and speed information is based on the outward speed of the wake disturbance.

14. The apparatus of claim 10, wherein the computer readable instructions further control the one or more processors to perform operations comprising:
determining, based on processing the disturbance record and a second disturbance record, an approach direction of the object with respect to the reference boundary,
wherein calculating the bearing and speed information is based on the approach direction of the object.

15. The apparatus of claim 10, wherein the computer readable instructions further control the one or more processors to perform operations comprising:
calculating, based on the disturbance record, a leading disturbance velocity associated with a wake disturbance and trailing disturbance velocity associated with the wake disturbance,
wherein calculating the bearing and speed information is based on the leading disturbance velocity and the trailing disturbance velocity.

16. A method comprising:
processing a disturbance record comprising a record of wake disturbances at a reference boundary according to time and position; and
calculating bearing and speed information associated with an object and a body of water based on processing the disturbance record,
wherein the bearing and speed information comprises:
a speed at which the object crossed a point along the reference boundary; and
a direction in which the object is traveling.

17. The method of claim 16, further comprising:
generating, based on processing the disturbance record, crossing extent information associated with the object and the reference boundary, wherein the crossing extent information comprises:
a location at the reference boundary at which the object crossed the reference boundary; and
temporal information associated with when the object crossed the reference boundary,
wherein calculating the bearing and speed information is based on processing the crossing extent information.

18. The method of claim 17, wherein:
the disturbance record comprises a wake pattern associated with a wake disturbance, and
the method further comprises:
identifying an angle of an apex associated with the wake pattern; and
generating the crossing extent information based on the angle of the apex.

19. The method of claim 16, further comprising:
calculating, based on processing the disturbance record, an outward speed of a wake disturbance from a location at the reference boundary where the wake disturbance is first observed,
wherein calculating the bearing and speed information is based on the outward speed of the wake disturbance.

20. The method of claim 16, further comprising:
determining, based on processing the disturbance record and a second disturbance record, an approach direction of the object with respect to the reference boundary,
wherein calculating the bearing and speed information is based on the approach direction of the object.
